(19) United States
(12) Patent Application Publication
(10) Pub. No.: US 2008/0018010 A1
(43) Pub. Date: Jan. 24, 2008

(54) System and Method for Manufacture of Extruded Polymer Materials

(76) Inventor: Charles M. Princell, Graham, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/611,491

(22) Filed: Dec. 15, 2006

Related U.S. Application Data
(60) Provisional application No. 60/820,010, filed on Jul. 21, 2006.

(51) Int. Cl. B29C 33/70; B29C 47/00; B28B 7/04

(52) U.S. Cl. 264/39; 264/176.1; 425/72.2

(57) ABSTRACT

A system and method for extruding polymer materials from an extrusion head includes a flow control valve for controlling the flow of polymer through and to the tooling of the extrusion head. A bypass valve is positioned upstream from the flow control valve for diverting the polymer flow from the flow control valve during a tooling change-out.

### CROSS-REFERENCE TO RELATED APPLICATIONS

The present application claims the benefit of U.S. Provisional Patent Applications Ser. Nos. 60/820,010, filed Jul. 21, 2006, the disclosures of which are incorporated herein by reference in their entireties.

### FIELD OF THE INVENTION

The present invention generally relates to the extrusion of polymer materials, and more particularly to a system and method for the manufacture of extruded polymer materials such as polyethylene foams that enables the rapid change out of extrusion tooling.

### BACKGROUND OF THE INVENTION

In conventional extrusion processes, molten polymer materials generally are extruded through a tooling set, such as a pin and die or simply a die, for forming extrusions of various shapes and/or configurations. For example, in the extrusion of polyethylene foam materials, such as for insulation for pipes and other articles, a molten polyethylene material typically is extruded through an extrusion head that includes a die and a pin so that a hollow, tubular extrusion is formed. Since the dies typically are limited to a specific size and/or configuration, to extrude specific shapes or size polymer extrusions or products, the tooling (such as the pin and/or die) must be changed out. On an active polymer extrusion system, changing out the tooling for the extrusion head typically requires that the extrusion system be shut down so that all molten polymer flow is stopped, with the processing temperatures for the polymer typically being reset to temperatures that are well in excess of standard processing temperatures to reduce molten polymer viscosity and minimize the extrusion head depressurization. If the polymer material is allowed to harden without having passed through the extrusion head, it can create a waste product that must be discarded. Thereafter, the time required to complete a tooling change-out and further allow the molten polymer material and the associated metal components of the extrusion system to cool down sufficiently to reach normal processing temperatures for the polymer extrusion can range anywhere from approximately 45-120 minutes or longer. Consequently, to accomplish a tooling change-out in most conventional extrusion systems, the extrusion system or line typically can be rendered non-operative for upwards of 1-2 hours, which can significantly limit production rates.

Accordingly, it can be seen that a need exists for a system and method for the manufacture of extruded polymer materials that addresses the foregoing and other related and unrelated problems in the art.

### SUMMARY OF THE INVENTION

Briefly described, the present invention generally relates to a system and method for the extrusion of polymer materials. The system and method of the present invention generally includes a dual function valve system mounted in the extrusion head of an extrusion system, including a flow control valve and a bypass value. The flow control valve includes a valve body and a valve stem that is rotatably received within the valve body and through which a flow passage for passage of the polymer material therethrough is defined. The valve stem is rotatable between an open position to enable the flow of polymer through the flow control valve, and a closed position blocking any further flow of polymer through the flow control valve and to the tooling of the extrusion head.

The tooling for the extrusion head is positioned at the downstream end of the extrusion head for extruding the polymer material into a desired shape or configuration. The tooling typically includes a die plate having a die opening or orifice of a size and/or configuration for extruding a specific size and shape extrusion, and also can include a pin, such as for forming a tubular extrusion. The die plate generally is secured within the extrusion head by a vented die holder that is mounted within the extrusion head. The vented die holder includes a body that defines a substantially circular central opening or passage therethrough. The die is seated on a sealing surface formed about the central passage of the die holder and a die retainer is secured thereover so as to form a substantially airtight, pressurized seal between the die and die holder during an extrusion operation. The die holder further includes a series of pressure vents, i.e., typically 2-4 pressure vents, although additional or fewer pressure vents also can be used, that are spaced about the circumference of the die holder for venting the pressure on the die during removal of the die from the die holder.

Upon a tooling change-out, the bypass valve, which is positioned at the upstream end of the extrusion head, is rotated to its opened position to enable at least a partial flow of molten polymer through a bypass channel and out of the extrusion head via the bypass valve. Thereafter, the flow control valve can be closed so as to shut off the molten polymer flow to the die and divert substantially 100% of the molten polymer to flow through the bypass into atmosphere. The pressure in the extrusion head is then vented at the die opening through the pressure vents formed through the die holder, after which the old tooling can be removed and new tooling installed. Once the new tooling has been installed, the flow control valve is returned to its open position to repressurize and restart the flow of molten polymer therethrough, after which the bypass valve can be closed.

Various objects, features and advantages of the present invention will become apparent to those skilled in the art upon review of the following detailed description, when taken in conjunction with the accompanying drawings.

### BRIEF DESCRIPTION OF THE DRAWINGS

FIG. 1 is a schematic illustration of an extrusion process utilizing the extrusion assembler system of the present invention.

FIG. 2 is a perspective view of the extrusion head for use in the system of the present invention.

FIG. 3 is an exploded perspective view illustrating the extrusion head with the die holder and die retainer fitting therein.

FIG. 4 is a perspective cross-sectional view of the extrusion head.

FIG. 5 is a side elevational view of the cleaning tool extending through the bypass valve of the present invention.

### DETAILED DESCRIPTION OF THE INVENTION

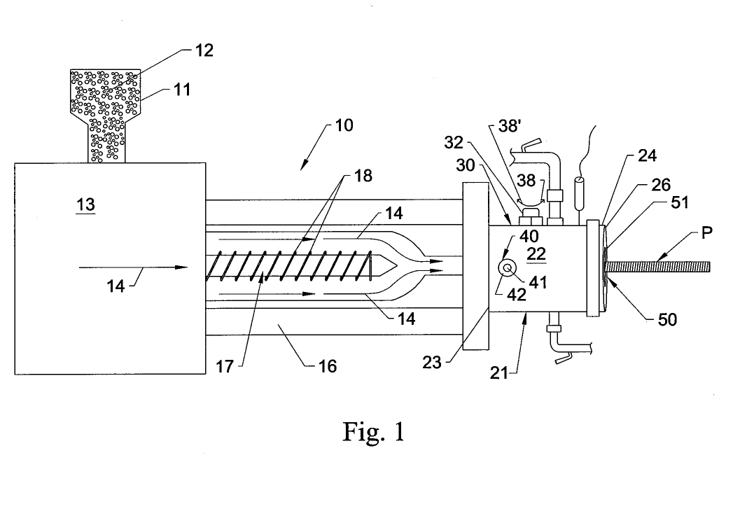

Referring now to the drawings in which like numerals indicate like parts throughout the several views, FIG. 1 generally illustrates an extrusion system or line 10 for use with the present invention. As schematically illustrated, the extrusion system 10 generally includes a polymer feed 11, which feeds a polymer material 12 into a plasticizing or heating unit 13 for placing the polymer material into a molten state for extrusion. The polymer material utilized in the extrusion system incorporating the present invention can include various types of polymers, such as a polyethylene material for forming polyethylene foam insulation materials such as for wrapping about pipes, insulation ducts, etc. It will be understood by those skilled in the art, however, that the principles of the present invention further can be applied to polymer extrusion systems and methods for extruding various other types and/or compositions of polymer materials for a variety of different applications.

The molten polymer material generally is fed in the direction of arrows 14 from the heating/plasticizing unit 13 through an extruder 16. The extruder 16 generally can include one or more screws 17 having a series of helical threads 18 formed thereabout for driving or pushing the molten polymer material in the direction of arrows 14. The polymer material is pushed through the extruder and to/through a downstream extrusion head 21 where the molten polymer material is extruded into a desired product shape or configuration, as indicated at P, such as for tubular foam pipe insulation or other structures.

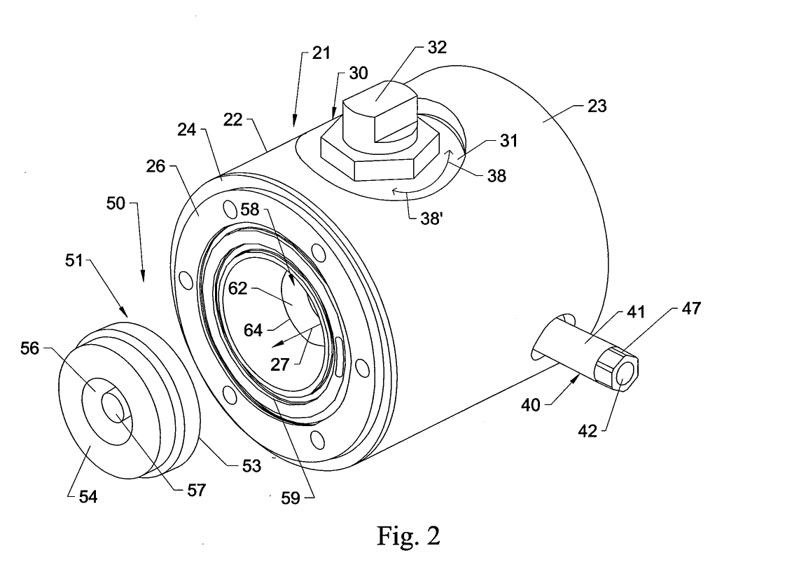

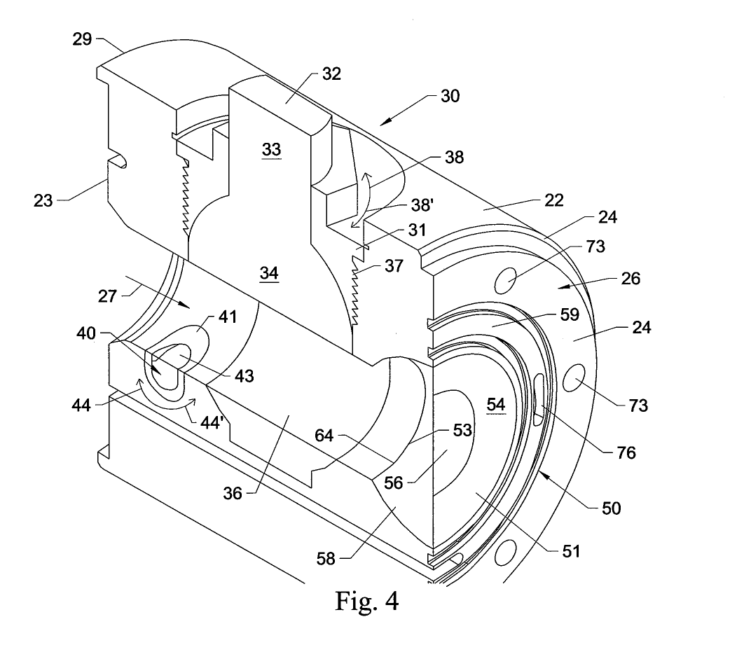

As generally illustrated in FIGS. 2-4, the extrusion head 21 generally includes a substantially cylindrically shaped body 22, typically formed from steel or other similar high strength material, and having an upstream end 23 in communication with the extruder 16 and an open downstream end 24. A collar or plate 26 is mounted or formed about the downstream end 24, with the body further generally defining a polymer flow passage 27 (FIG. 4) for the passage of the molten polymer material therethrough. As generally illustrated in FIGS. 2 and 4, a flow control valve 30 is positioned along the body 22 of the extrusion head 21, upstream from the collar 26 and downstream end 24 of the extrusion head. The flow control valve generally includes a valve body 31, in which a valve stem 32 is rotatably received. As illustrated in FIG. 4, the valve stem includes an upper end 33 that projects upwardly out of the body of the extrusion head 21, and includes a rounded, hollow body or lower section 34 having a passage 36 formed therethrough. The valve stem typically is threadably or otherwise attached to the body of the extrusion head, as indicated at FIG. 37 in FIG. 4, to enable rotation of the flow control valve 30 in the direction of arrows 38 and 38′. As a result, the valve stem of the flow control valve is moved between an open position with its passage 36 in alignment with the polymer flow passage 27 to enable the polymer material to fully pass through the extrusion head, and a closed position in which the polymer flow passage 27 of the extrusion head is substantially blocked.

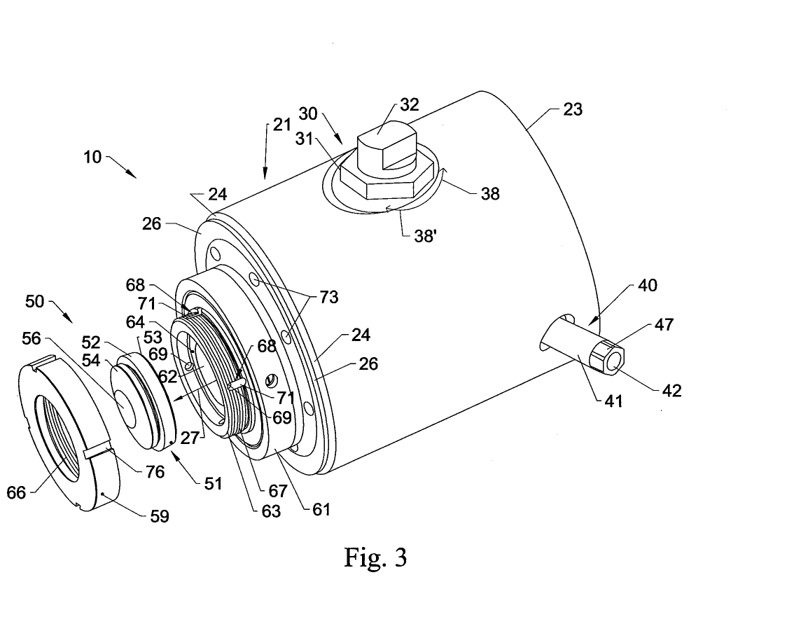

As additionally indicated in FIGS. 2-4, a bypass valve 40 is mounted within the body of the extrusion head, positioned upstream from the flow control valve 30. The bypass valve generally includes a tubular body 41 that extends through one or both sides of the body 22 of the extrusion head 21, terminating at one or more outlets 42. A valve port or inlet 43 (FIG. 4) is formed along a portion of the tubular body 41 of the bypass valve 40 that extends through the flow channel 27 of the extrusion head. The bypass valve 40 is rotated in the direction of arrows 44 and 44′ between a closed position, in which its inlet or valve port 43 is blocked or turned out of communication with the flow passage 27 of the extrusion head, and an opened position whereby the inlet is in open communication with the flow passage 27. With the bypass valve in its opened position, molten polymer material flowing through the extrusion head can be diverted and passed into and through a bypass channel 46 defined through the tubular body of the bypass valve. As further illustrated in FIGS. 2 and 3, a hexagonally shaped nut or similar fastener 47 can be mounted along one or both of the outlet ends 42 of the bypass valve to provide an engaging or gripping surface for a tool, such as a wrench or similar tool, to engage the bypass valve for rotating the bypass valve in the direction of arrows 44 and 44′ (FIG. 4) between its open and closed positions.

As generally illustrated in FIG. 3, the extrusion tooling 50 for the extrusion system typically is mounted within the downstream end 24 of the extrusion head 21, generally being affixed to or sealed against the downstream end by locking collar or plate 26. The extrusion tooling typically comprises a die 51 that generally is a substantially cylindrically shaped member having a rear body portion 52 defining a sealing surface or seat 53 along a rear edge thereof, and a substantially conically shaped forward portion 54 having one or more die openings 56 formed therein. It will be understood by that the die opening can be formed as a circular orifice (as shown) or can be formed in various other shapes or configurations depending upon the size and/or configuration of the product to be extruded. In addition, as indicated in FIG. 2, a pin 57 also can be mounted approximately in the center of the die opening 56 such as for use in forming tubular foamed polymer extrusions having a substantially hollow passage or channel formed in the center thereof.

As further indicated in FIG. 3, the die 51 is received and held within the extrusion head 21 by a die holder 58 and a retainer 59. The die holder generally includes a cylindrical body 61 defining a control passage 62 therethrough and having a reduced diameter forward end 63 with a sealing surface 64 formed about an internal wall thereof. The die 51 is received with its seat or sealing surface 53 engaging and seating against the sealing surface 64 of the die holder, as indicated in FIG. 3. The die retainer 59 generally is then placed thereover and engages and attaches to the front end 63 of the die holder 58, such as by engagement of screw threads 66 and 67, or similar attachment mechanisms. As a result, as the screw threads 66 and 67 of the retainer 59 and die holder 58, respectively, are engaged and the retainer tightened against the die holder, the die 51 is substantially locked in sealing engagement within the downstream end of the extruder head.

As additionally illustrated in FIG. 3, the die holder 58 is a vented die holder having one or more pressure vents 68 formed in spaced series about the circumference of the front end 63 of the die holder. The pressure vents generally include openings 69 formed through the front end 63 of the die holder. The openings 69 are in open communication with the central passage 62 formed through the die holder 58, and open into slots 71 that extend rearwardly along the die holder. The passages 72 communicate with vent openings 73 formed through the body and downstream plate of the extrusion head to enable venting of pressure built up behind the die to atmosphere as needed for change-out of the tooling of the extrusion system. While FIG. 3 illustrates four vents spaced approximately 90° apart, it will, however, be understood that various numbers, i.e., 1-4 or more numbers of vents, and vents of different sizes and configurations also can be utilized with the present invention. The pressure vents further typically will be substantially equally spaced so as to provide equalization of the pressure vented therethrough. As additionally illustrated in FIG. 3, the die retainer 59 includes a series of slots 76 formed in spaced series about its circumference. These slots are open at the downstream end of the extrusion head and are designed to facilitate the engagement of the locking tool for unlocking and removing the die holder for replacement of the tooling and cleaning of the extrusion head and for the tooling change-out operation.

In operation of the extrusion system according to the principles of the present invention, during a tooling change-out, as an initial step, the extrusion head temperature is slightly increased to approximately 275° in all zones, while the remaining parameters such as pressure and flow volume, typically can remain the same. Thereafter, the bypass valve 40 (FIGS. 2-4) is opened, typically using a standard adjustable wrench or similar tool, by engaging the nut 47 (FIGS. 2 and 3) attached to at least one outlet 42 of the bypass valve. The bypass valve is rotated in the direction of arrow 44 (FIG. 4) to open the inlet port 43 to the flow passage 27 to enable at least a portion of the polymer flow passing through the extrusion head to be diverted and pass into and through the bypass channel 46.

Upon initially opening the bypass valve, between approximately 20% to 30% of the molten polymer flow can be diverted into the hollow stem of the bypass valve and to atmosphere through the outlet ends of the bypass valve. Once the flow through the bypass valve has been stabilized, the flow control valve 30 is engaged and rotated in the direction of arrows 38′ so as to close the flow control valve and shut off the flow of molten polymer through and to the extrusion head tooling 50. The closing of the flow control valve further causes approximately 100% of the molten polymer flow to then be diverted through the bypass valve and into the atmosphere. With the polymer flow diverted, the extrusion head can be quickly depressurized, with the pressure being vented at the die opening.

To vent the pressure on the die within the extrusion head, an operator loosens the die retainer, such as by unscrewing the die retainer from the die holder. This allows the die to be moved forwardly in response to residual pressure in the extrusion head behind the die, thus breaking the seal between the die and die holder sealing surfaces 53 and 64, respectively (FIG. 3). Thereafter, the tooling 50, which can include the die and/or die pin, can be removed to enable cleaning of the die holder and the change-out and installation of new tooling. At this point, the time required for the removal and installation of new tooling can be accomplished in approximately 10 minutes, or possibly less, depending upon the amount of cleaning or material that must be removed from the extrusion head prior to the installation of the new tooling.

Once the tooling change has been completed, and the retaining nut re-secured to lock the new tooling in place within the extrusion head, the flow control valve then is opened to enable at least a partial flow of molten polymer to be redirected through the flow passage of the extruder head and through the new tooling. Thereafter, with the flow control valve in its opened condition, the bypass valve will be slowly closed, with the rate at which the bypass valve is closed being controlled so as to control the return of the full polymer flow and the pressure to extrusion head. This controlled return to flow of the polymer material helps avoid spikes in pressure or other problems as the flow of polymer through the extrusion head tooling is brought to its full flow rate and pressure.

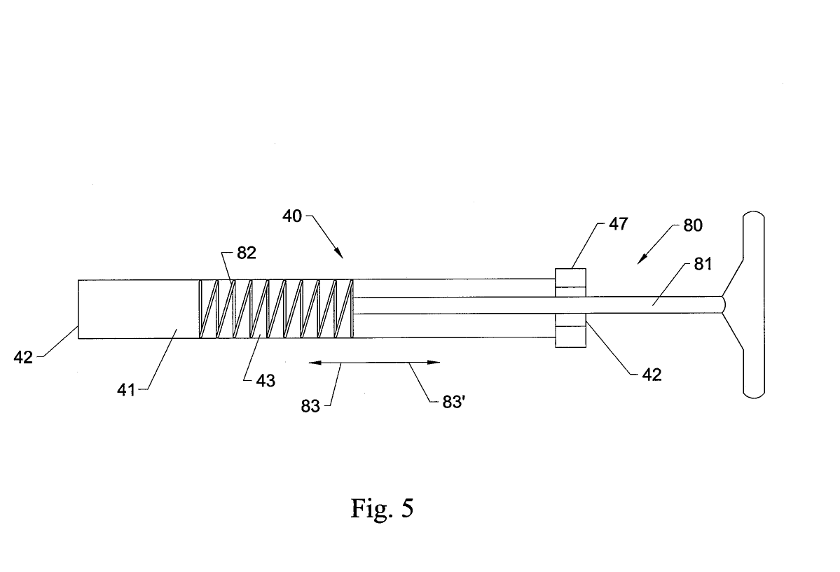

After the bypass valve has been closed, any residual polymer then must be cleaned from the bypass channel to avoid fouling or clogging of the bypass channel. Such a cleaning operation typically is accomplished utilizing a cleaning tool 80 as illustrated in FIG. 5. The cleaning tool 80 generally has an elongated, flexible shaft 81 with a corkscrew-type scraping element 82 attached at the distal end thereof. The cleaning tool is inserted through one outlet end 42 of the bypass valve and is rotated as it is moved back and forth in the direction of arrows 83 and 83′, so as to scrape the sides of the bypass channel of the bypass valve and substantially clean the bypass valve of any residual polymer material remaining therein.

At approximately the same time as full flow pressure is returned to the extrusion head, the extrusion head temperature is reduced to process set points, the extrusion product is restrung and the die centering can be completed to stabilize the extrusion process. As a result, with the present invention, the change-out of the tooling 50 of the extrusion head can be accomplished and the extrusion head brought back into full operation within approximately 20-25 minutes so as to substantially reduce the downtime of the extrusion line. In addition, since the foamed polymer material has been vented to atmosphere during the change-out, it typically can be recovered and recycled so as to further reduce the amount of waste required for the product change-out. Still further, the present process does not require significant increases in processing temperature of the polymer material and metal components for the extrusion line in order to accomplish a tooling change-out, which further can reduce the polymer processing issues and production time.

It will be further understood by those skilled in the art that while the present invention has been described above with reference to preferred embodiments, numerous variations, modifications, and additions can be made thereto without departing from the spirit and scope of the present invention as set forth in the following claims.

What is claimed:

1. An extrusion head for a polymer extrusion system, comprising:
a flow control valve positioned along the extrusion head of the polymer extrusion system, said flow control valve comprising a valve body defining a flow passage through which a flow of polymer passes through the extrusion head, and a valve stem projecting from said valve body and through the extrusion head for opening and closing said flow control valve;
a bypass valve positioned within the extrusion head upstream from said flow control valve, said bypass valve defining a bypass channel through which the flow of polymer passing through the extrusion head can be diverted as said flow control valve is closed; and
a die mounted at a downstream end of the extrusion head for controlling the extrusion of the polymer in a desired configuration.

2. The extrusion head of claim 1 and further comprising a vented die holder mounted to the extrusion head in a position for sealing said die within the extrusion head.

3. The extrusion head of claim 2 and wherein said vented die holder comprises a die holder having a die sealing surface and at least one pressure vent formed therein, and a retainer adapted to releasably mount to said die holder with said die engaged therebetween.

4. The extrusion head of claim 3 and wherein said at least one pressure vent comprises a plurality of openings formed in said die holder and spaced approximately 30° to approximately 180° about said die sealing surface.

5. The extrusion head of claim 1 and further comprising a vented die holder having a series of two to four pressure vents at spaced locations about the circumference, and a series of vent openings in communication with said pressure vents for venting pressure in the extrusion head.

6. The extrusion head of claim 1 and wherein said bypass valve comprises an elongated body having at least one outlet projecting outwardly from the extrusion head and a bypass valve port in communication with said bypass channel for enabling passage of the flow of polymer into said bypass channel as said bypass valve is moved to an opened position.

7. A method of replacing tooling in an extrusion head for polymer extrusion systems, comprising:
closing a flow control valve and diverting a flow of polymer material passing through the extrusion head to a bypass valve;
with the flow of polymer diverted, removing and replacing the tooling in the extrusion head;
opening the flow control valve;
reestablishing at least a partial flow of the polymer through the flow control valve and extrusion head; and
closing the bypass valve to return full polymer flow and pressure to the extrusion head.

8. The method of claim 7 and further comprising increasing extrusion head temperature to at least approximately 250° F. prior to opening the bypass valve.

9. The method of claim 7 and further comprising equalizing the pressure in the extrusion head with atmospheric pressure after closing the flow control valve to a level sufficient to enable removal of the tooling from the extrusion head.

10. The method claim 7 and further comprising cleaning a die holder and retainer of the extrusion head.

11. The method of claim 7 and wherein closing the bypass valve comprise rotating the bypass valve to a closed position at a reduced rate sufficient to enable controlled increase of polymer flow and pressure to full polymer flow rates and pressure for extrusion.

12. The method of claim 7 and further comprising reducing extrusion head temperature to a desired temperature for extrusion of the polymer following return of full polymer flow and pressure.

13. The method of claim 7 and wherein removing and replacing the tooling comprises removing a die retainer and die from a die holder of the extrusion head, cleaning the die holder of excess built up polymer material, inserting a replacement die in the die holder and reapplying the die retainer to secure the replacement die in the die holder.
